(19) United States
(12) Patent Application Publication
(10) Pub. No.: US 2025/0141084 A1
(43) Pub. Date: May 1, 2025

(54) TRANSPARENT ANTENNA

(71) Applicant: INDUSTRIAL TECHNOLOGY RESEARCH INSTITUTE, Hsinchu (TW)

(72) Inventors: Li-Yang TSAI, Luodong Township (TW); Bing-Hsun LI, Hsinchu City (TW); Kuang-Hui SHIH, Tainan City (TW); Yu-Ching LIN, Zhudong Township (TW)

(73) Assignee: INDUSTRIAL TECHNOLOGY RESEARCH INSTITUTE, Hsinchu (TW)

(21) Appl. No.: 18/921,876

(22) Filed: Oct. 21, 2024

Related U.S. Application Data
(60) Provisional application No. 63/545,573, filed on Oct. 25, 2023.

(30) Foreign Application Priority Data
Aug. 23, 2024 (TW) 113131905

(51) Int. Cl. H01Q 1/12; H01Q 1/48; H01Q 9/30; H01Q 13/10

(52) U.S. Cl. CPC H01Q 1/1271; H01Q 1/48; H01Q 9/30; H01Q 13/106

(57) ABSTRACT

A transparent antenna is provided. A transparent antenna includes a transparent dielectric substrate, a plurality of antenna conductive layers, a feeding layer and a plurality of grounding layers. The antenna conductive layers are disposed on a first surface of the transparent dielectric substrate. The feeding layer is disposed on the first surface of the transparent dielectric substrate and is connected to the antenna conductive layers. Each of the antenna conductive layer, the feeding layer and the grounding layer is a mesh structure. The antenna conductive layers and the grounding layers corresponding thereto form a plurality of antenna units. The antenna conductive layers of the antenna units are not all the same; or the grounding layers of the antenna units are not all the same.

This application claims the benefit of U.S. Provisional application Ser. No. 63/545,573, filed Oct. 25, 2023 and Taiwan application Serial No. 113131905, filed Aug. 23, 2024, the disclosure of which is incorporated by reference herein in its entirety.

### TECHNICAL FIELD

The disclosure relates to a transparent antenna.

### BACKGROUND

Traditional antennas do not have light transparence, so when it is used in building windows, vehicle sunroofs and vehicle side windows, they will encounter problems of blocking the field of view and being in conflict with the environment. When an antenna with dual frequency bands or above is required, the number of the antennas will be increased a lot, and applications in glass windows, vehicle sunroofs, vehicle side windows and other related fields will face higher challenges.

Therefore, the industry needs to develop an antenna with dual-band or triple-band functions that has good transparence and good radiation, so as to expand multi-band antennas to applications such as buildings and vehicles.

### SUMMARY

The disclosure is directed to a transparent antenna. Through the mesh structure and dual-band antenna design, the transparent antenna not only exhibits high transparence, but also has good radiation efficiency at multiple frequencies.

According to one embodiment, a transparent antenna is provided. The transparent antenna includes a transparent dielectric substrate, a plurality of antenna conductive layers, a feeding layer and a plurality of grounding layers. The antenna conductive layers are disposed on a first surface of the transparent dielectric substrate. The feeding layer is disposed on the first surface of the transparent dielectric substrate, and connected to the antenna conductive layer. Each of the antenna conductive layers, the feeding layer and the grounding layers is a mesh structure. The antenna conductive layers and the grounding layers corresponding thereto form a plurality of antenna units. The antenna conductive layers of the antenna units are not all identical; or the grounding layers of the antenna units are not all identical.

According to another embodiment, a transparent antenna is provided. The transparent antenna includes a transparent dielectric substrate, a plurality of antenna conductive layers, a feeding layer and a plurality of grounding layers. The antenna conductive layers are disposed on a first surface of the transparent dielectric substrate. The feeding layer is disposed on the first surface of the transparent dielectric substrate and connected to the antenna conductive layers. Each of the antenna conductive layers, the feeding layer and the grounding layers is a mesh structure. The antenna conductive layers and the grounding layers corresponding thereto form a plurality of antenna unit. Two of the antenna units which are adjacent have identical frequency band. A distance between the antenna units with identical frequency band is ½ to 1 of a medium wavelength.

According to an alternative embodiment, a transparent antenna includes a transparent dielectric substrate, a plurality of antenna conductive layers, a feeding layer and a plurality of grounding layers. The antenna conductive layers are disposed on a first surface of the transparent dielectric substrate. The feeding layer is disposed on the first surface of the transparent dielectric substrate and connected to the antenna conductive layers. Each of the antenna conductive layers, the feeding layer and the grounding layers is a mesh structure. The antenna conductive layers and the grounding layers corresponding thereto form a plurality of antenna units. Each of the antenna units has at least one frequency band, and the frequency bands of the antenna units are not all identical.

### BRIEF DESCRIPTION OF THE DRAWINGS

FIG. 1A illustrates a top view of the transparent antenna according to one embodiment of the present disclosure.

FIG. 1B shows a side view of the transparent antenna in the FIG. 1A.

FIG. 1C shows a bottom view of the transparent antenna in the FIG. 1A.

FIG. 1D shows a mesh structure of the transparent antenna in the FIG. 1A.

FIG. 2A illustrates a top view of a transparent antenna according to an embodiment of the present disclosure.

FIG. 2B illustrates a return loss curve of the transparent antenna in the FIG. 2A.

FIG. 3A illustrates a top view of a transparent antenna according to another embodiment.

FIG. 3B illustrates a return loss curve of the transparent antenna in the FIG. 3A.

FIG. 4A illustrates a top view of a transparent antenna according to an embodiment.

FIG. 4B illustrates a return loss curve of the transparent antenna in the FIG. 4A.

FIG. 5A illustrates a top view of a transparent antenna according to an embodiment of the present disclosure.

FIG. 5B illustrates a side view of the transparent antenna in the FIG. 5A.

FIG. 5C illustrates a bottom view of the transparent antenna in the FIG. 5A.

FIG. 5D shows the mesh structure of the transparent antenna in the FIG. 5A.

FIG. 6A illustrates a top view of a transparent antenna according to another embodiment of the present disclosure.

FIG. 6B illustrates a side view of the transparent antenna in the FIG. 6A.

FIG. 6C illustrates a bottom view of the transparent antenna in the FIG. 6A.

FIG. 6D shows the mesh structure of the transparent antenna in the FIG. 6A.

FIG. 7A shows a top view of a transparent antenna according to another embodiment of the present disclosure.

FIG. 7B shows a side view of the transparent antenna in the FIG. 7A.

FIG. 7C shows a bottom view of the transparent antenna in the FIG. 7A.

FIG. 7D shows the mesh structure of the transparent antenna in the FIG. 7A.

FIG. 8A shows a top view of a transparent antenna according to an embodiment of the present disclosure.

FIG. 8B shows a side view of the transparent antenna in the FIG. 8A.

FIG. 8C shows a bottom view of the transparent antenna in the FIG. 8A.

FIG. 8D shows the mesh structure of the transparent antenna in the FIG. 8A.

FIG. 9A shows a top view of a transparent antenna according to an embodiment of the present disclosure.

FIG. 9B shows a side view of the transparent antenna in the FIG. 9A.

FIG. 9C shows a bottom view of the transparent antenna in the FIG. 9A.

FIG. 9D illustrates a mesh structure of the transparent antenna in the FIG. 9A.

FIG. 10A illustrates a top view of a transparent antenna according to an embodiment of the present disclosure.

FIG. 10B illustrates a side view of the transparent antenna in the FIG. 10A.

FIG. 10C illustrates a bottom view of the transparent antenna in the FIG. 10A.

FIG. 10D shows the mesh structure of the transparent antenna in FIG. 10A.

FIG. 11A illustrates a top view of the transparent antenna according to an embodiment of the present disclosure.

FIG. 11B illustrates a side view of the transparent antenna in the FIG. 11A.

FIG. 11C illustrates a bottom view of the transparent antenna in FIG. 11A.

FIG. 11D shows the mesh structure of the transparent antenna in the FIG. 11A.

FIGS. 12A to 12C illustrate the various designs of the main grid line.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

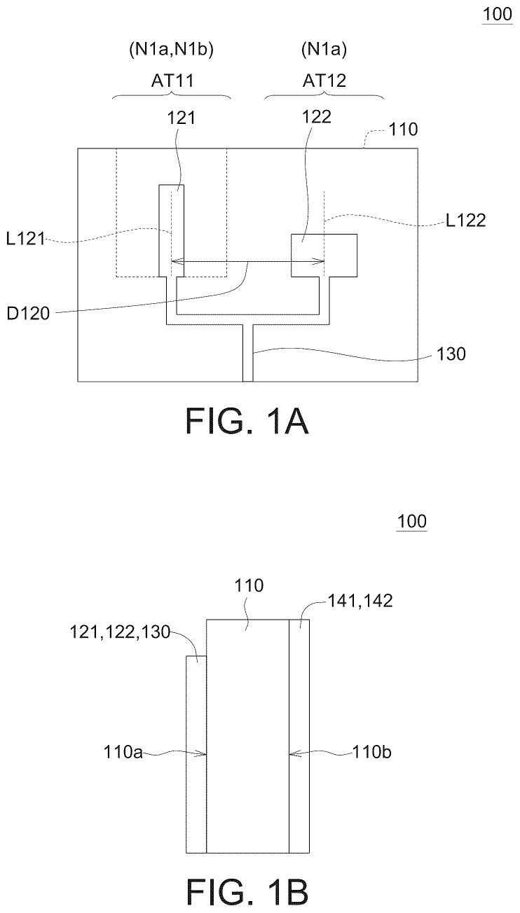

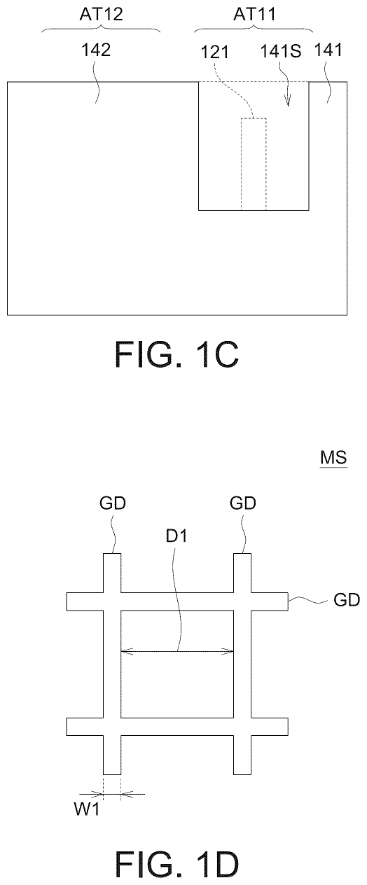

Please refer to FIGS. 1A to 1D. FIG. 1A illustrates a top view of the transparent antenna 100 according to one embodiment of the present disclosure. FIG. 1B shows a side view of the transparent antenna 100 in the FIG. 1A. FIG. 1C shows a bottom view of the transparent antenna 100 in the FIG. 1A. FIG. 1D shows a mesh structure MS of the transparent antenna 100 in the FIG. 1A. The transparent antenna 100 includes a transparent dielectric substrate 110, a plurality of antenna conductive layers 121, 122, a feeding layer 130 and a plurality of grounding layers 141, 142. The transparent dielectric substrate 110 is, for example but not limited to, a single-layer structure or a multi-layer structure. The transparent dielectric substrate 110 has a first surface 110a and a second surface 110b. The material of the transparent dielectric substrate 110 is, for example, a transparent glass plate or a transparent acrylic plate.

The materials of the antenna conductive layer 121, 122 and the grounding layer 141, 142 are, for example, metal or metal oxide. The antenna conductive layers 121 and 122 are disposed on the first surface 110a of the transparent dielectric substrate 110. The feeding layer 130 is disposed on the first surface 110a of the transparent dielectric substrate 110 and connected to the antenna conductive layers 121 and 122. The grounding layers 141 and 142 are disposed on the second surface 110b of the transparent dielectric substrate 110. The grounding layer 141 has a hole 141S.

The antenna conductive layer 121 and the grounding layer 141 form an antenna unit AT11, and the antenna conductive layer 122 and the grounding layer 142 form an antenna unit AT12. The positions of the antenna unit AT11 and the antenna unit AT12 could be interchanged. The antenna unit AT11 is, for example, a dual band monopole slot antenna unit, which has a frequency band N1a and a frequency band N1b. The antenna unit AT12 is, for example, a single band microstrip antenna unit, which has a frequency band N1a. In other words, the antenna unit AT11 has the frequency band N1a of the antenna unit AT12.

The distance D120 between the antenna unit AT11 and the antenna unit AT12, which both have the frequency band N1a, is ½ to 1 of the medium wavelength. The medium is the transmission medium for radiation signals, such as air. The distance D120 is the distance between a central line L121 of the antenna conductive layer 121 and a central line L122 of the antenna conductive layer 122. Through the design of the distance D120, the radiation field patterns of the two adjacent antenna units AT11 and AT12 could obtain gain synthesis.

As shown in the FIG. 1D, each of the antenna conductive layers 121, 122, the feeding layer 130 and the grounding layers 141, 142 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width W1 of each of the main grid lines GD is, for example, 5 to 100 μm.

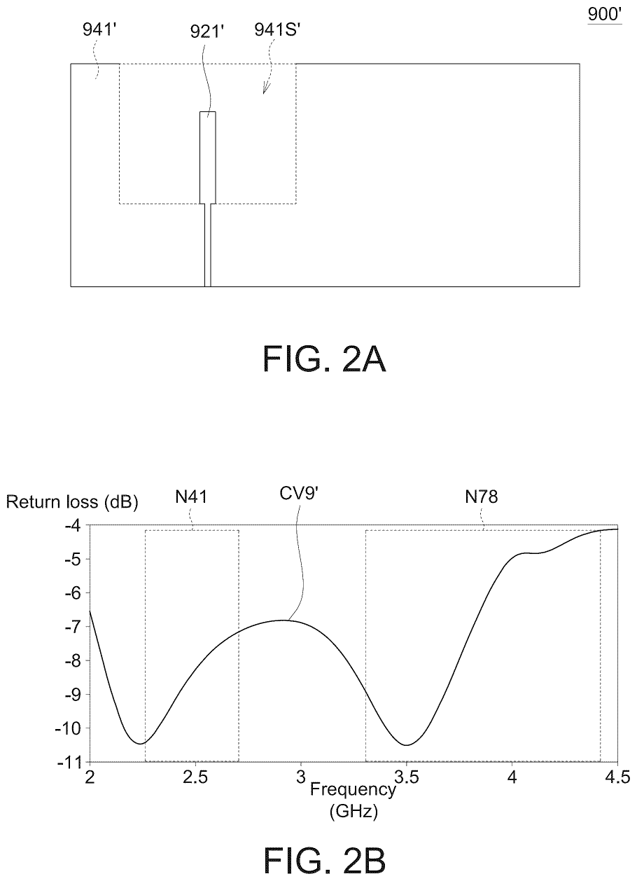

Please refer to FIGS. 2A to 2B. FIG. 2A illustrates a top view of a transparent antenna 900′ according to an embodiment of the present disclosure. FIG. 2B illustrates a return loss curve CV9′ of the transparent antenna 900′ in the FIG. 2A. The transparent antenna 900′ in FIG. 2A adopts a design equivalent to the antenna unit AT11 in FIGS. 1A to 1D. The grounding layer 941′ corresponding to the antenna conductive layer 921′ has a hole 941S′

As shown in the return loss curve CV9′ of FIG. 2B, the transparent antenna 900′ in FIG. 2A could achieve good results at a frequency band N41 and a frequency band N78. In the transparent antenna 900′ of FIG. 2A, the peak gain at the frequency band N41 could reach 4.87 dBi, and the peak gain at the frequency band N78 could reach 4.43 dBi.

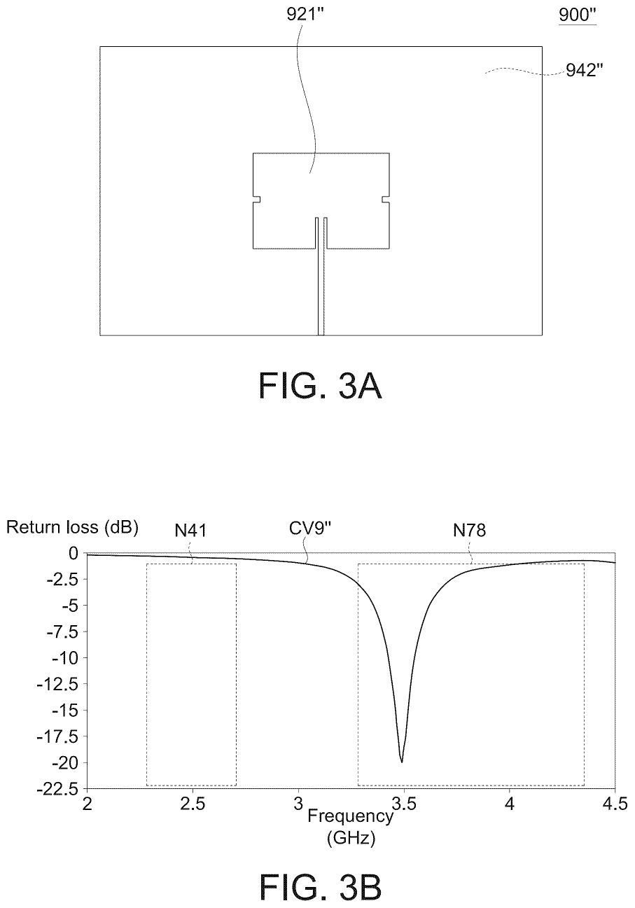

Please refer to FIG. 3A to FIG. 3B. FIG. 3A illustrates a top view of a transparent antenna 900″ according to another embodiment. FIG. 3B illustrates a return loss curve CV9″ of the transparent antenna 900″ in the FIG. 3A. The transparent antenna 900″ in the FIG. 3A adopts a design equivalent to the antenna unit AT12 in the FIGS. 1A to 1D. The grounding layer 942″ corresponding to the antenna conductive layer 921″ has no opening hole.

As shown in FIG. 3B, according to the return loss curve CV9″, the transparent antenna 900″ in the FIG. 3A could achieve good results at the frequency band N78. In the transparent antenna 900″ of the FIG. 3A, the peak gain at the frequency band N78 could reach 5.75 dBi.

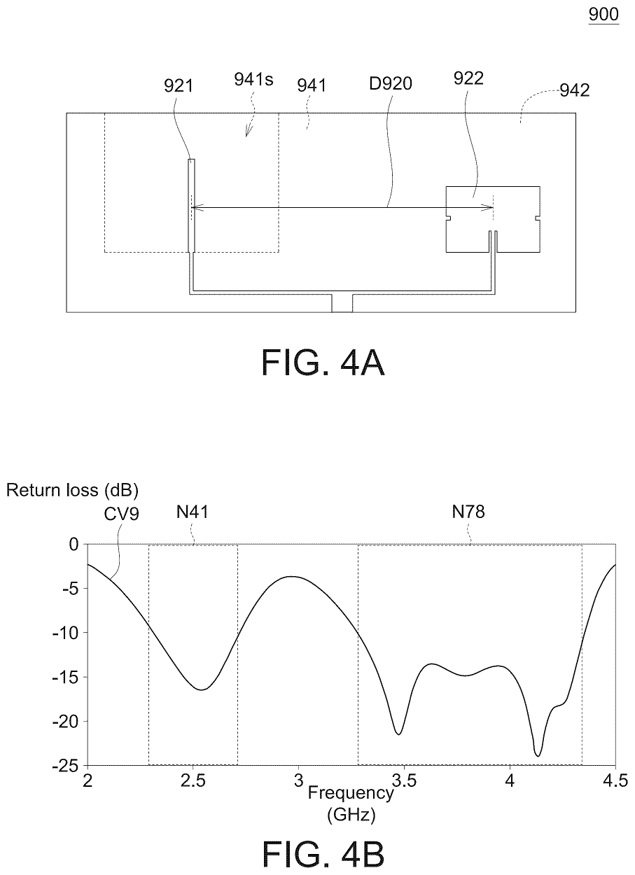

Please refer to FIGS. 4A to 4B. FIG. 4A illustrates a top view of a transparent antenna 900 according to an embodiment. FIG. 4B illustrates a return loss curve CV9 of the transparent antenna 900 in the FIG. 4A. The transparent antenna 900 in the FIG. 4A adopts the design equivalent to the antenna unit AT11 and the antenna unit AT12 in the FIGS. 1A to 1D. The grounding layer 941 corresponding to the antenna conductive layer 921 has a hole 941S, and the grounding layer 942 corresponding to the antenna conductive layer 922 has no hole. The distance D920 between the antenna conductive layer 921 and the antenna conductive layer 922 is ½ to 1 of the medium wavelength.

As shown in the return loss curve CV9 in the FIG. 4B, the transparent antenna 900 in FIG. 4A could achieve good results in the frequency band N41 and the frequency band N78. In the transparent antenna 900 of the FIG. 4A, a peak gain at the frequency band N41 could reach 5.12 dBi, and the peak gain at the frequency band N78 could reach 8.03 dBi. It is obvious that through proper design of the distance D920, the radiation fields of the two adjacent antenna units AT11 and AT12 could obtain gain synthesis, so that the peak gain of the frequency band N78 could be increased to 8.03 dBi, which is higher than that of the transparent antenna 900′ in the FIG. 2A or the transparent antenna 900″ in the FIG. 3A.

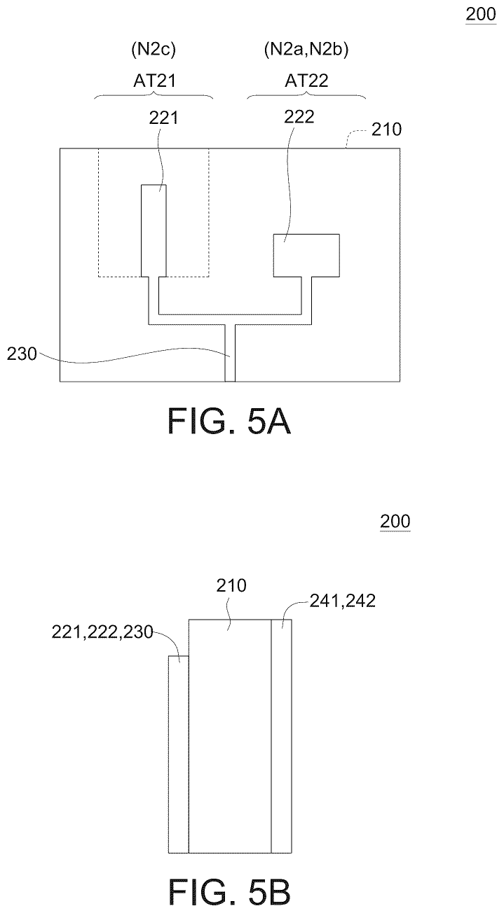

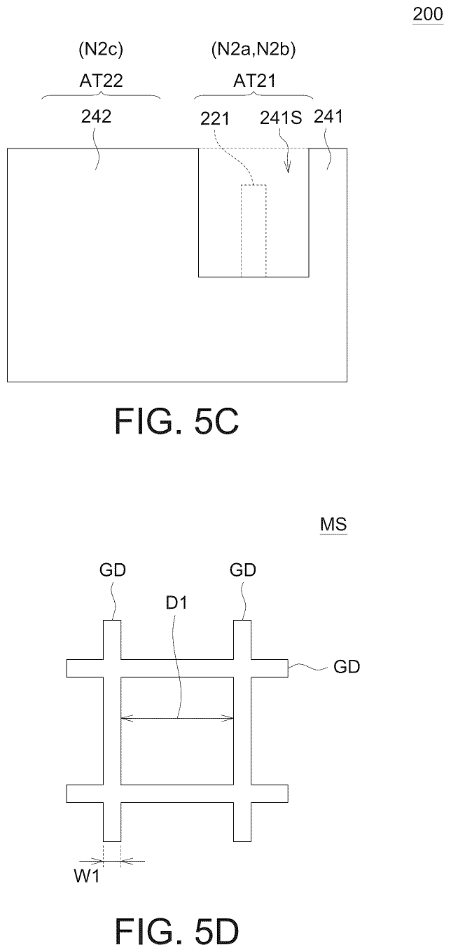

Please refer to FIGS. 5A to 5D. FIG. 5A illustrates a top view of a transparent antenna 200 according to an embodiment of the present disclosure. FIG. 5B illustrates a side view of the transparent antenna 200 in the FIG. 5A. FIG. 5C illustrates a bottom view of the transparent antenna 200 in the FIG. 5A. FIG. 5D shows the mesh structure MS of the transparent antenna 200 in the FIG. 5A. In the embodiment shown in the FIGS. 5A to 5D, the transparent antenna 200 includes a transparent dielectric substrate 210, a plurality of antenna conductive layers 221, 222, a feeding layer 230 and a plurality of grounding layers 241, 242. The transparent dielectric substrate 210 is, for example but not limited to, a single-layer structure or a multi-layer structure. The material of the transparent dielectric substrate 210 is, for example, a transparent glass plate or a transparent acrylic plate.

The material of the antenna conductive layer 221, 222 and the grounding layer 241, 242 is, for example, metal. The feeding layer 230 is connected to the antenna conductive layers 121, 122. The grounding layer 241 has a hole 241S.

The antenna conductive layer 221 and the grounding layer 241 corresponding thereto form an antenna unit AT21, and the antenna conductive layer 222 and the grounding layer 242 corresponding thereto form an antenna unit AT22. The positions of the antenna unit AT21 and the antenna unit AT22 could be interchanged. The antenna unit AT21 is, for example, a dual band monopole slot antenna unit, which has a frequency band N2a and a frequency band N2b. The antenna unit AT22 is, for example, a single band microstrip antenna unit, which has a frequency band N2c. In other words, the antenna unit AT21 does not contain the frequency band N2c of the antenna unit AT22.

As shown in the FIG. 5D, each of the antenna conductive layers 221, 222, the feeding layer 230 and the grounding layers 241, 242 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width W1 of the main grid line GD is, for example, 5 to 100 μm.

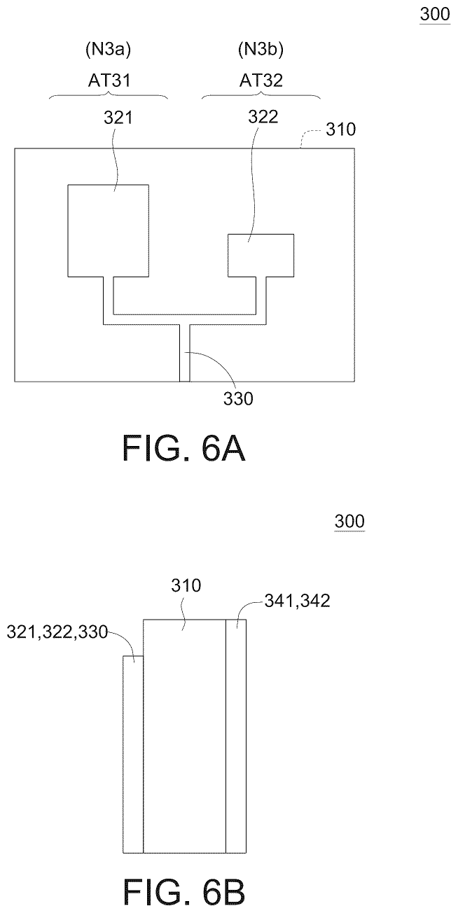

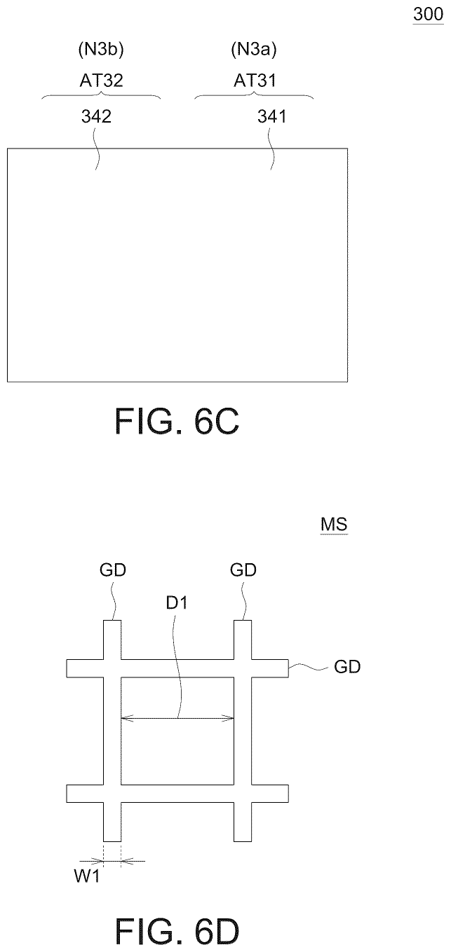

Please refer to FIGS. 6A to 6D. FIG. 6A illustrates a top view of a transparent antenna 300 according to another embodiment of the present disclosure. FIG. 6B illustrates a side view of the transparent antenna 300 in the FIG. 6A. FIG. 6C illustrates a bottom view of the transparent antenna 300 in the FIG. 6A. FIG. 6D shows the mesh structure MS of the transparent antenna 300 in the FIG. 6A. In the embodiment of the FIGS. 6A to 6D, the transparent antenna 300 includes a transparent dielectric substrate 310, a plurality of antenna conductive layers 321, 322, a feeding layer 330 and a plurality of grounding layers 341, 342. The transparent dielectric substrate 310 is, for example but not limited to, a single-layer structure or a multi-layer structure. The material of the transparent dielectric substrate 310 is, for example, a transparent glass plate or a transparent acrylic plate.

The material of the antenna conductive layer 321, 322 and the grounding layer 341, 342 is, for example, metal. The feeding layer 330 is connected to the antenna conductive layers 321, 322. The grounding layers 341, 342 have no holes.

The antenna conductive layer 321 and the grounding layer 341 corresponding thereto form an antenna unit AT31, and the antenna conductive layer 322 and the grounding layer 342 corresponding thereto form an antenna unit AT32. The positions of the antenna unit AT31 and the antenna unit AT32 could be interchanged. The antenna unit AT31 is, for example, a single band microstrip antenna unit, which has a frequency band N3a. The antenna unit AT32 is, for example, a single band microstrip antenna unit, which has a frequency band N3b. That is to say, the antenna unit AT31 does not include the frequency band N3b of the antenna unit AT32.

As shown in the FIG. 6D, each of the antenna conductive layers 321, 322, the feeding layer 330 and the grounding layers 341, 342 is the mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width of each of the main grid lines GD is W1 is, for example, 5 to 100 μm.

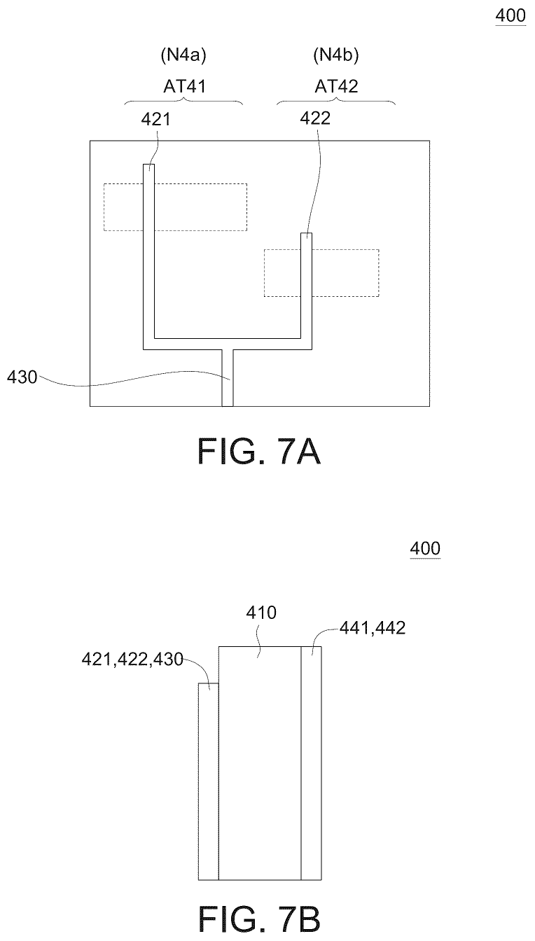

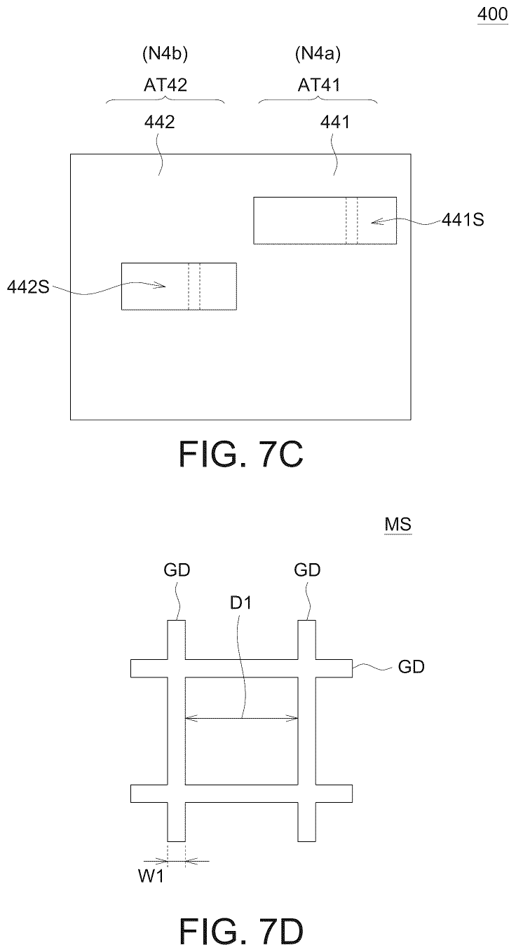

Please refer to FIGS. 7A to 7D. FIG. 7A shows a top view of a transparent antenna 400 according to another embodiment of the present disclosure. FIG. 7B shows a side view of the transparent antenna 400 in the FIG. 7A. FIG. 7C shows a bottom view of the transparent antenna 400 in the FIG. 7A. FIG. 7D shows the mesh structure MS of the transparent antenna 400 in the FIG. 7A. In the embodiment of the FIGS. 7A to 7D, the transparent antenna 400 includes a transparent dielectric substrate 410, a plurality of antenna conductive layers 421, 422, a feeding layer 430 and a plurality of grounding layers 441, 442. The transparent dielectric substrate 410 is, for example but not limited to, a single-layer structure or a multi-layer structure. The material of the transparent dielectric substrate 410 is, for example, a transparent glass plate or a transparent acrylic plate.

The material of the antenna conductive layers 421, 422 and the grounding layers 441, 442 is, for example, metal. The feeding layer 430 is connected to the antenna conductive layers 421, 422. The grounding layer 441 has a hole 441S, and the grounding layer 442 also has a hole 442S.

The antenna conductive layer 421 and the grounding layer 441 corresponding thereto form the antenna unit AT41, and the antenna conductive layer 422 and the grounding layer 442 corresponding thereto form the antenna unit AT42. The positions of the antenna unit AT41 and the antenna unit AT42 could be interchanged. The antenna unit AT41 is, for example, a single band slot antenna unit, which has a frequency band N4a. The antenna unit AT42 is, for example, a single band slot antenna unit, which has a frequency band N4b. That is to say, the antenna unit AT41 does not include the frequency band N4b of the antenna unit AT42.

As shown in the FIG. 7D, each of the antenna conductive layers 421, 422, the feeding layer 430 and the grounding layers 441, 442 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width of each of the main grid lines GD is W1 is, for example, 5 to 100 μm.

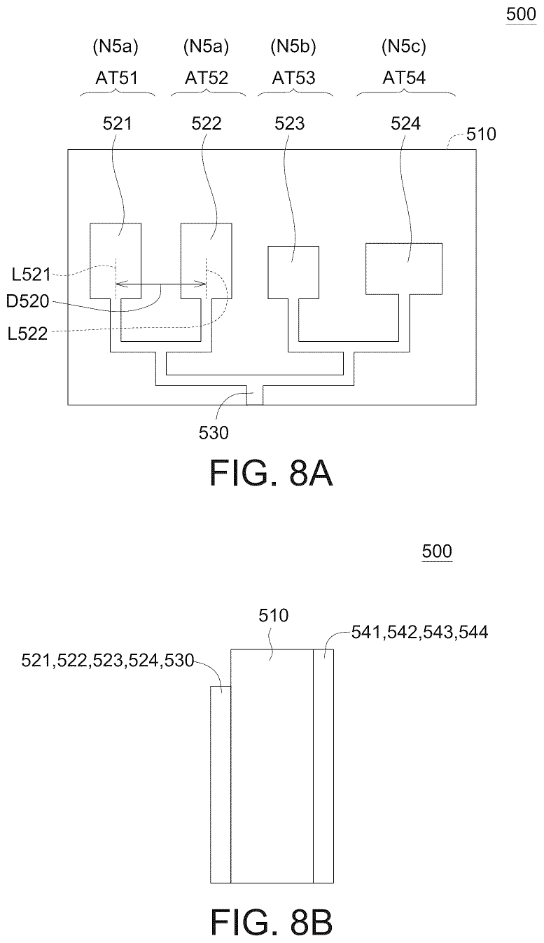

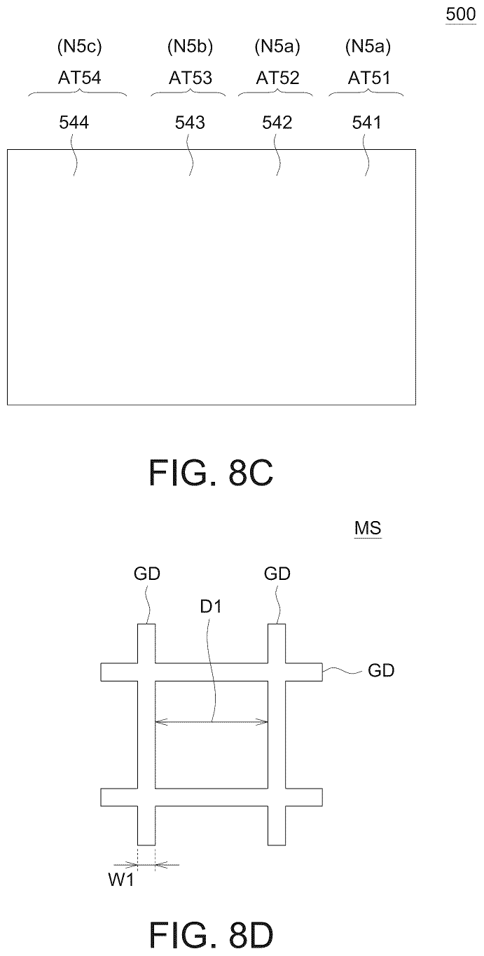

Please refer to FIGS. 8A to 8D. FIG. 8A shows a top view of a transparent antenna 500 according to an embodiment of the present disclosure. FIG. 8B shows a side view of the transparent antenna 500 in the FIG. 8A. FIG. 8C shows a bottom view of the transparent antenna 500 in the FIG. 8A. FIG. 8D shows the mesh structure MS of the transparent antenna 500 in the FIG. 8A. The transparent antenna 800 includes a transparent dielectric substrate 510, a plurality of antenna conductive layers 521, 522, 523, 524, a feeding layer 530 and a plurality of grounding layers 541, 542, 543, 544. The transparent dielectric substrate 510 is, for example but not limited to, a single-layer structure or a multi-layer structure. The material of the transparent dielectric substrate 510 is, for example, a transparent glass plate or a transparent acrylic plate.

The material of the antenna conductive layers 521, 522, 523, 524 and the grounding layers 541, 542, 543, 544 is, for example, metal. The feeding layer 530 is connected to the antenna conductive layers 521, 522, 523, 524.

The antenna conductive layer 521 and the grounding layer 541 corresponding thereto form an antenna unit AT51, the antenna conductive layer 522 and the grounding layer 542 corresponding thereto form an antenna unit AT52, the antenna conductive layer 523 and the grounding layer 543 corresponding thereto form an antenna unit AT53, and the antenna conductive layer 524 and the grounding layer 544 corresponding thereto form an antenna unit AT54 The positions of the antenna unit AT51, the antenna unit AT52, the antenna unit AT53, and the antenna unit AT54 could be interchanged. The antenna units AT51 to AT54 are, for example, single-band or multi-band antennas. The antenna units AT51 to AT54 are, for example, slot antenna units, microstrip antenna units or dipole slot antenna units, etc. The antenna unit AT51 has a frequency band N5a, the antenna unit AT52 has the frequency band N5a, the antenna unit AT53 has a frequency band N5b, the antenna unit AT54 has a frequency band N5c.

The distance D520 between the antenna unit AT51 and the antenna unit AT52 that have the identical frequency band N5a is between ½ to 1 of the medium wavelength. The medium is the transmission medium for radiation signals, such as air. The distance D520 is the distance between the central line L521 of the antenna conductive layer 521 and the central line L522 of the antenna conductive layer 522. Through appropriate design of the distance D520, the radiation field patterns of the two adjacent antenna units AT51 and AT52 could obtain gain synthesis.

As shown in the FIG. 8D, each of the antenna conductive layers 521, 522, 523, 524, the feeding layer 530 and the grounding layers 541, 542, 523, 524 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width W1 of each of the main grid line GD is, for example, 5 to 100 μm.

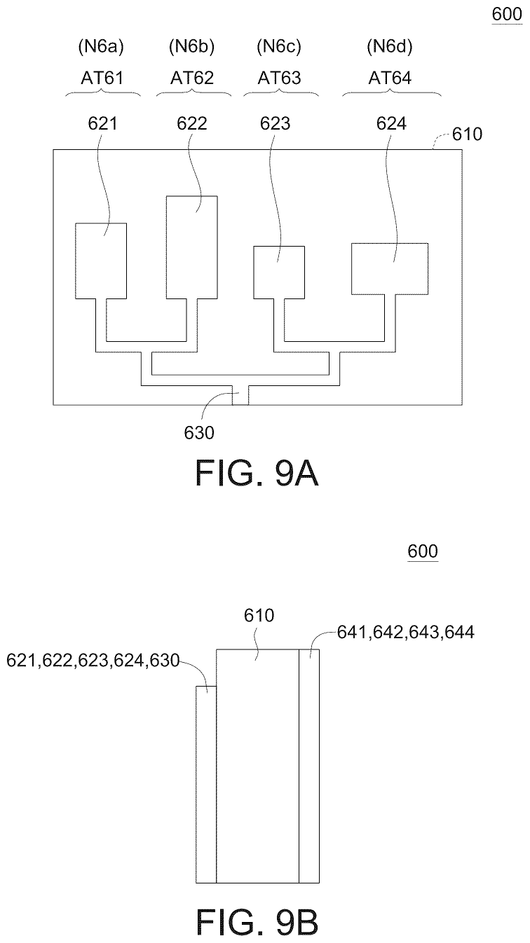

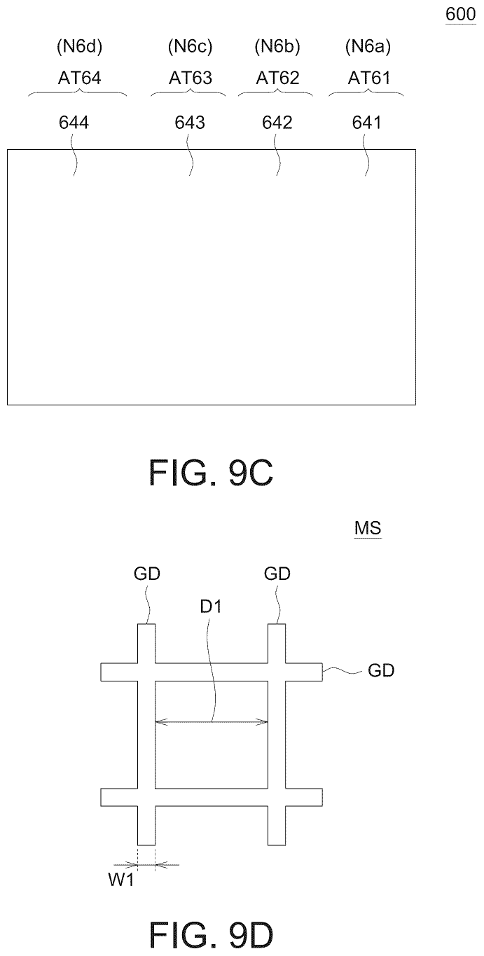

Please refer to FIGS. 9A to 9D. FIG. 9A shows a top view of a transparent antenna 600 according to an embodiment of the present disclosure. FIG. 9B shows a side view of the transparent antenna 600 in the FIG. 9A. FIG. 9C shows a bottom view of the transparent antenna 600 in the FIG. 9A. FIG. 9D illustrates a mesh structure MS of the transparent antenna 600 in the FIG. 9A. The transparent antenna 600 includes a transparent dielectric substrate 610, a plurality of antenna conductive layers 621, 622, 623, 624, a feeding layer 630 and a plurality of grounding layers 641, 642, 643, 644. The transparent dielectric substrate 610 is, for example but not limited to, a single-layer structure or a multi-layer structure. The material of the transparent dielectric substrate 610 is, for example, a transparent glass plate or a transparent acrylic plate.

The material of the antenna conductive layer 621, 622, 623, 624 and the grounding layer 641, 642, 643, 644 is, for example, metal. The feeding layer 630 is connected to the antenna conductive layers 621, 622, 623, 624.

The antenna conductive layer 621 and the grounding layer 641 corresponding thereto form an antenna unit AT61, the antenna conductive layer 622 and the grounding layer 642 corresponding thereto form an antenna unit AT62, the antenna conductive layer 623 and the grounding layer 643 corresponding thereto form an antenna unit AT63, the antenna conductive layer 624 and the grounding layer 644 corresponding thereto form an antenna unit AT64. The positions of the antenna unit AT61, the antenna unit AT62, the antenna unit AT63 and the antenna unit AT64 could be interchanged. The antenna units AT61 to AT64 are, for example, single-band or multi-band antennas. The antenna units AT61 to AT64 are, for example, slot antenna units, microstrip antenna units or dipole slot antenna units, etc. The antenna unit AT61 has a frequency band N6a, the antenna unit AT62 has a frequency band N6b, the antenna unit AT63 has a frequency band N6c, the antenna unit AT64 has a frequency band N6d.

As shown in the FIG. 9D, each of the antenna conductive layers 621, 622, 623, 624, the feeding layer 630 and the grounding layers 641, 642, 643, 644 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width W1 of each of the main grid lines GD is, for example, 5 to 100 μm.

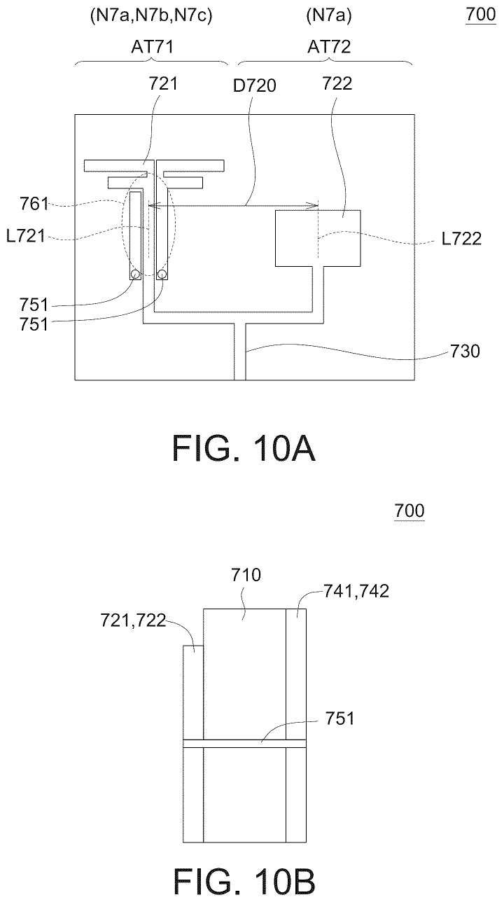

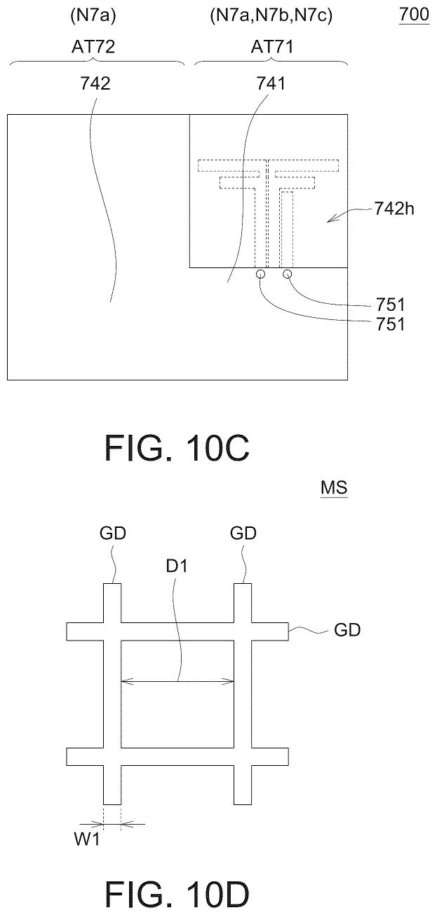

Please refer to FIGS. 10A to 10D. FIG. 10A illustrates a top view of a transparent antenna 700 according to an embodiment of the present disclosure. FIG. 10B illustrates a side view of the transparent antenna 700 in the FIG. 10A. FIG. 10C illustrates a bottom view of the transparent antenna 700 in the FIG. 10A. FIG. 10D shows the mesh structure MS of the transparent antenna 700 in FIG. 10A. The transparent antenna 700 includes a transparent dielectric substrate 710, a plurality of antenna conductive layers 721, 722, a feeding layer 730 and a plurality of grounding layers 741, 742. The transparent dielectric substrate 710 is, for example but not limited to, a single-layer structure or a multi-layer structure. The material of the transparent dielectric substrate 710 is, for example, a transparent glass plate or a transparent acrylic plate.

The material of the antenna conductive layers 721, 722 and the grounding layers 741, 742 is, for example, metal. The feeding layer 730 is connected to the antenna conductive layers 721, 722.

The antenna conductive layer 721 and the grounding layer 741 corresponding thereto form an antenna unit AT71, and the antenna conductive layer 722 and the grounding layer 742 corresponding thereto form an antenna unit AT72. The positions of the antenna unit AT71 and the antenna unit AT72 could be interchanged. The antenna unit AT71 is, for example, a three-band dipole antenna. The antenna unit AT72 is, for example, a single-band microstrip antenna. The grounding layer 742 has a hollow area 742h (shown in FIG. 10C). The antenna unit AT71 has frequency bands N7a, N7b, N7c, and the antenna unit AT72 has the frequency band N7a. That is, the antenna unit AT71 contains the frequency band N7a of the antenna unit AT72. The antenna unit AT71 has a coplanar waveguide (CPW) transmission line structure 761. Both sides of the CPW transmission line structure 761 are connected to the grounding layer 741 through conductive via 751. The middle of the CPW transmission line structure 761 is connected to the feeding layer 730.

The distance D720 between the antenna unit AT71 and the antenna unit AT72 having the same frequency band N7a is between ½ to 1 of the medium wavelength. The medium is the transmission medium for radiation signals, such as air. The distance D720 is the distance between a central line L721 of the antenna conductive layer 721 and a central line L722 of the antenna conductive layer 722. Through appropriate design of the distance D720, the radiation field patterns of two adjacent antenna units AT71 and AT72 could achieve gain synthesis.

As shown in the FIG. 10D, each of the antenna conductive layers 721, 722, the feeding layer 730 and the grounding layers 741, 742 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width of each of the main grid lines GD is W1 is, for example, 5 to 100 μm.

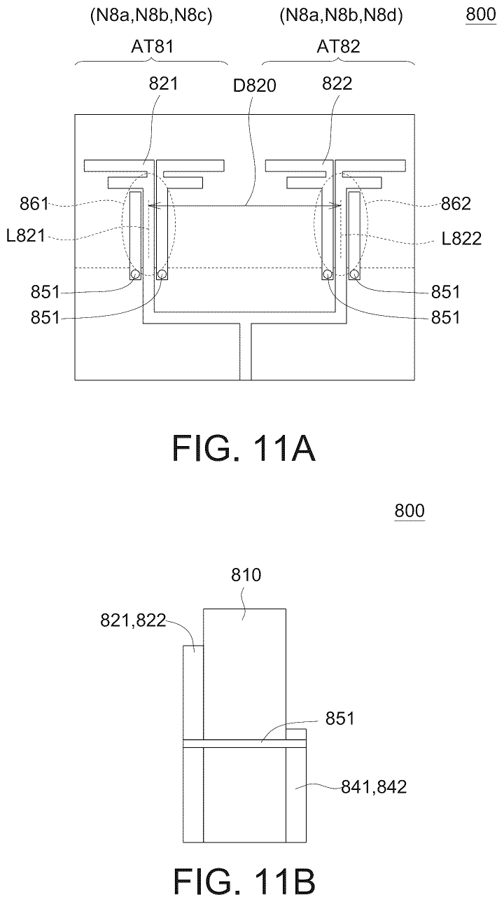

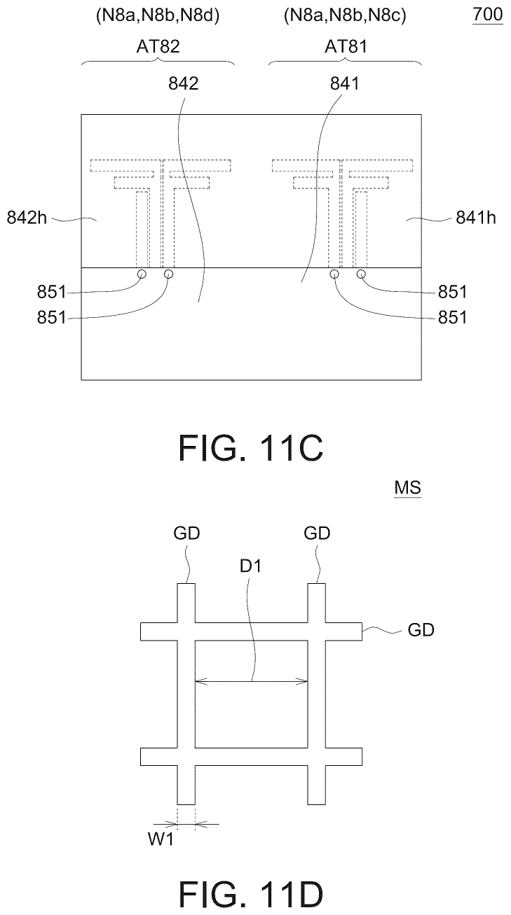

Please refer to FIGS. 11A to 11D. FIG. 11A illustrates a top view of the transparent antenna 800 according to an embodiment of the present disclosure. FIG. 11B illustrates a side view of the transparent antenna 800 in the FIG. 11A. FIG. 11C illustrates a bottom view of the transparent antenna 800 in FIG. 11A. FIG. 11D shows the mesh structure MS of the transparent antenna 800 in the FIG. 11A. The transparent antenna 800 includes a transparent dielectric substrate 810, a plurality of antenna conductive layers 821, 822, a feeding layer 830, a plurality of grounding layers 841, 842 and two conductive vias 851. The grounding layer 841 has a hollow area 841h (shown in FIG. 11C), and the grounding layer 842 has a hollow area 842h (shown in FIG. 11C). The transparent dielectric substrate 810 is, for example but not limited to, a single-layer structure or a multi-layer structure. The material of the transparent dielectric substrate 810 is, for example, a transparent glass plate or a transparent acrylic plate.

The material of the antenna conductive layers 821, 822 and the grounding layers 841, 842 is, for example, metal. The feeding layer 830 is connected to the antenna conductive layers 821, 822. The conductive via 851 connects the antenna conductive layers 821, 822 and the grounding layers 841, 842.

The antenna conductive layer 821 and the grounding layer 841 corresponding thereto form an antenna unit AT81, the antenna conductive layer 822 and the grounding layer 842 corresponding thereto form an antenna unit AT82. The positions of the antenna unit AT81 and the antenna unit AT82 could be interchanged. The antenna unit AT81 and the antenna unit AT82 are, for example, three-band dipole antennas. The grounding layer 842 includes a hollow area. The antenna unit AT81 has frequency bands N8a, N8b, N8c, and the antenna unit AT82 has frequency bands N8a, N8b, N8d. That is to say, the antenna unit AT81 includes the frequency bands N8a, N8b of the antenna unit AT82. The antenna unit AT81 has a CPW transmission line structure 861. Both sides of the CPW transmission line structure 861 are connected to the grounding layer 841 through the conductive via 851, and the middle of the CPW transmission line structure 861 is connected to the feeding layer 830. The antenna unit AT82 has a CPW transmission line structure 862. Both sides of the CPW transmission line structure 862 are connected to the grounding layer 842 through conductive via 851, and the middle of the CPW transmission line structure 862 is connected to the feeding layer 830.

The distance D820 between the antenna unit AT81 and the antenna unit AT82 having the same frequency band N8a is between ½ to 1 of the medium wavelength. The medium is the transmission medium for radiation signals, such as air. The distance D820 is the distance between a central line L821 of the antenna conductive layer 821 and a central line L822 of the antenna conductive layer 822. Through appropriate design of the distance D820, the radiation field patterns of the two adjacent antenna units AT81 and AT82 could obtain gain synthesis.

As shown in the FIG. 11D, each of the antenna conductive layers 821, 822, the feeding layer 830 and the grounding layers 841, 842 is a mesh structure MS. The mesh structure MS includes a plurality of staggered main grid lines GD. The main grid lines GD are substantially parallel or perpendicular to each other. The spacing D1 among the main grid lines GD is less than 1/20 of the medium wavelength, and the width W1 of each of the main grid lines GD is, for example, 5 to 100 μm.

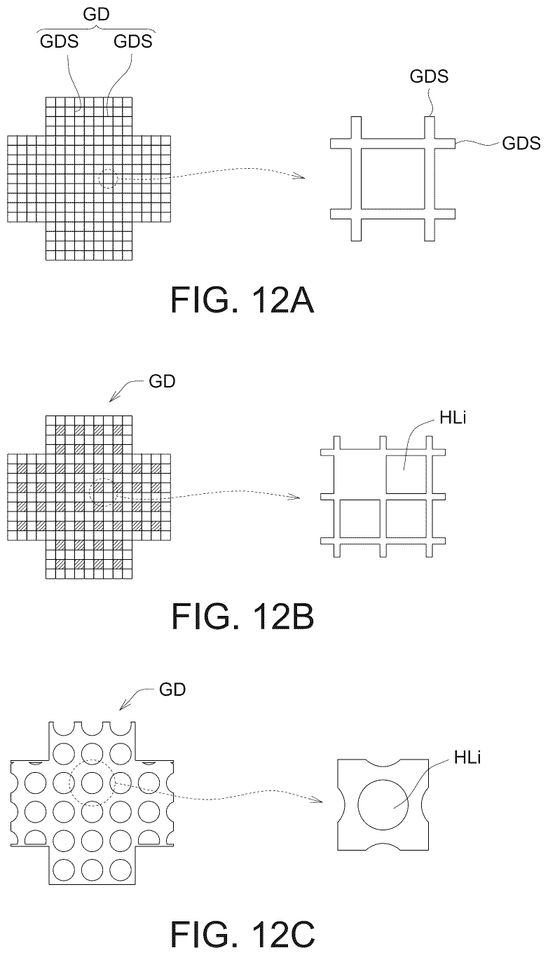

Please refer to FIGS. 12A to 12C, which illustrate the various designs of the main grid line GD. As shown in the FIG. 12A, the main grid line GD includes a plurality of staggered secondary grid lines GDS. The secondary grid lines GDS are substantially parallel or perpendicular to each other. Through the design of the secondary grid lines GDS, the main grid lines GD could have high transparency.

As shown in the FIG. 12B, the main grid lines GD could also have a plurality of holes HLi. Each of the holes HLi is, for example, a square structure. The holes HLi are regularly arranged in an array (There are holes HLi at some positions on the array, and there is no holes HLi at some positions on the array). Through the design of the holes HLi, the main grid lines GD could have high transparency.

As shown in the FIG. 12C, each of the holes HLi of the main grid lines GD is circular. In another embodiment, each of the holes HLi could be a triangle, a hexagon, or any other shape. Through the design of the holes HLi, the main grid lines GD could have high transparency.

Through the design of the mesh structure and the antenna units in the above embodiments, the transparent antenna could not only exhibit high transparency, but also have good radiation efficiency at multiple frequencies, and could be widely used in vehicles and buildings.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A transparent antenna, comprising:
a transparent dielectric substrate;
a plurality of antenna conductive layers, disposed on a first surface of the transparent dielectric substrate;
a feeding layer, disposed on the first surface of the transparent dielectric substrate, and connected to the antenna conductive layer; and
a plurality of grounding layers, wherein each of the antenna conductive layers, the feeding layer and the grounding layers is a mesh structure;
wherein the antenna conductive layers and the grounding layers corresponding thereto form a plurality of antenna units; and the antenna conductive layers of the antenna units are not all identical; or the grounding layers of the antenna units are not all identical.

2. The transparent antenna according to claim 1, wherein the grounding conductive layers are disposed on a second surface of the transparent dielectric substrate.

3. The transparent antenna according to claim 1, wherein the transparent dielectric substrate is a single-layer structure.

4. The transparent antenna according to claim 1, wherein the transparent dielectric substrate is a multi-layer structure.

5. The transparent antenna according to claim 1, wherein the antenna conductive layers of the antenna units are different, and the grounding layers of the antenna units are identical.

6. The transparent antenna according to claim 1, wherein the grounding layers of the antenna units are different.

7. The transparent antenna according to claim 1, wherein the antenna conductive layers of the antenna units are different, and the grounding layers of the antenna units are different.

8. The transparent antenna according to claim 1, wherein a distance among the antenna units is ½ to 1 of a medium wavelength.

9. The transparent antenna according to claim 8, wherein the distance among the antenna units is a distance among central lines of the antenna conductive layers.

10. The transparent antenna according to claim 1, wherein the antenna units include a dual band monopole slot antenna unit and a single band microstrip antenna unit.

11. The transparent antenna according to claim 1, wherein the antenna units include two single band microstrip antenna units.

12. The transparent antenna according to claim 1, wherein the antenna units include two single band slot antenna units.

13. The transparent antenna according to claim 1, wherein each of the mesh structures includes a plurality of main grid lines which are staggered, the main grid lines are substantially parallel or perpendicular to each other, and a width of each of the main grid lines is 5 to 100 μm.

14. The transparent antenna according to claim 13, wherein a spacing among the main grid lines is less than 1/20 of a medium wavelength.

15. The transparent antenna according to claim 13, wherein each of the main grid lines includes a plurality of secondary grid lines which are staggered.

16. The transparent antenna according to claim 13, wherein each of the main grid lines includes a plurality of holes.

17. A transparent antenna, comprising:
a transparent dielectric substrate;
a plurality of antenna conductive layers, disposed on a first surface of the transparent dielectric substrate;
a feeding layer, disposed on the first surface of the transparent dielectric substrate and connected to the antenna conductive layers; and
a plurality of grounding layers, wherein each of the antenna conductive layers, the feeding layer and the grounding layers is a mesh structure;
wherein the antenna conductive layers and the grounding layers corresponding thereto form a plurality of antenna unit, two of the antenna units which are adjacent have identical frequency band, and a distance between the antenna units with identical frequency band is ½ to 1 of a medium wavelength.

18. A transparent antenna, comprising:
a transparent dielectric substrate;
a plurality of antenna conductive layers, disposed on a first surface of the transparent dielectric substrate;
a feeding layer, disposed on the first surface of the transparent dielectric substrate and connected to the antenna conductive layers; and
a plurality of grounding layers, wherein each of the antenna conductive layers, the feeding layer and the grounding layers is a mesh structure;
wherein the antenna conductive layers and the grounding layers corresponding thereto form a plurality of antenna units, each of the antenna units has at least one frequency band, and the frequency bands of the antenna units are not all identical.

19. The transparent antenna according to claim 18, wherein some of the frequency bands of the antenna units are identical, and some of the frequency bands of the antenna units are different.

20. The transparent antenna according to claim 18, wherein the frequency bands of the antenna units are different.
